(19) United States
(12) Patent Application Publication
(10) Pub. No.: US 2012/0079755 A1
(43) Pub. Date: Apr. 5, 2012

(54) Submersible and/or floating aquatic LED light to attract fish and/or for night diving

(76) Inventors: Nelson Jorge Torres, Miami, FL (US); Nelson Bernadino Torres, Miami, FL (US)

(21) Appl. No.: 12/924,672

(22) Filed: Oct. 1, 2010

(51) Int. Cl. A01K 85/01

(52) U.S. Cl. 43/17.5

(57) ABSTRACT

A process for building a submersible and/or a floating aquatic LED light to attract fish and/or for night diving. An aquatic LED light that has all light house and disco light effect eliminated by wrapping the LED lights in a spiral design and is encased in a electrical isolative transparent material.

### FIELD OF THE INVENTION

The present invention relates to submergible lights, primarily to underwater LED lights to attract fish and/or night diving.

### BACKGROUND OF THE INVENTION

Modern designs for submersible lights to attract fish commonly provide illumination by means of fluorescent lighting. Although the fluorescent lights work well, they are very fragile and often break. Other illumination means are provided by LED lights, but lack the design to prevent a lighthouse or disco light effect and electrical isolative material to protect against water intrusion and abuse. Although the lights still function and illuminate, the lighthouse and disco effect tend to startle any fish that is nearby. Therefore exists the need for a submersible LED light where the LED strip(s) are rotated in a spiral design to remove the lighthouse and disco effect. There also exist a need to have an electrical isolative material to protect the LED strip(s) from water intrusion and abuse.

### SUMMARY OF THE INVENTION

The present invention overcomes the disadvantages and shortcomings of the prior art discussed above by providing a new and improved submersible LED light which eliminates the lighthouse and disco light effects. More particularly, the submersible light includes LED strip(s), a center rod to wrap the LED strip(s) in a spiral design, an electrical isolative transparent material, and weighted material to help submerge the light.

### BRIEF DESCRIPTION OF THE DRAWINGS

For a more complete understanding of the present invention, reference is made to the following detailed description of exemplary embodiments of the present invention, considered in conjunction with the accompanying drawings, in which:

FIG. 1 is a perspective exploded view of the aquatic LED light.

FIG. 2 is a perspective view of an underwater light assembly constructed with the LED strips wrapped around the center rod horizontally.

FIG. 3 is a perspective view of an underwater light assembly constructed with the LED strips wrapped around the center rod vertically.

### DETAILED DESCRIPTION OF THE INVENTION

Although the present invention can be used in conjunction with any type of underwater lighting application, it is particularly suitable for use in attracting fish and the like. The light may also be used to help divers locate an object during a night dive or any other poor lighted area. Accordingly, the present invention will be described hereinafter in connection with attracting fish and night diving. It should be understood, however, that the following description is only meant to be illustrative of the present invention and is not meant to limit the scope of the present invention, which has applicability to other types of underwater applications, such as aquariums, fish ponds, water park rides, and/or venues for viewing aquatic animal performances.

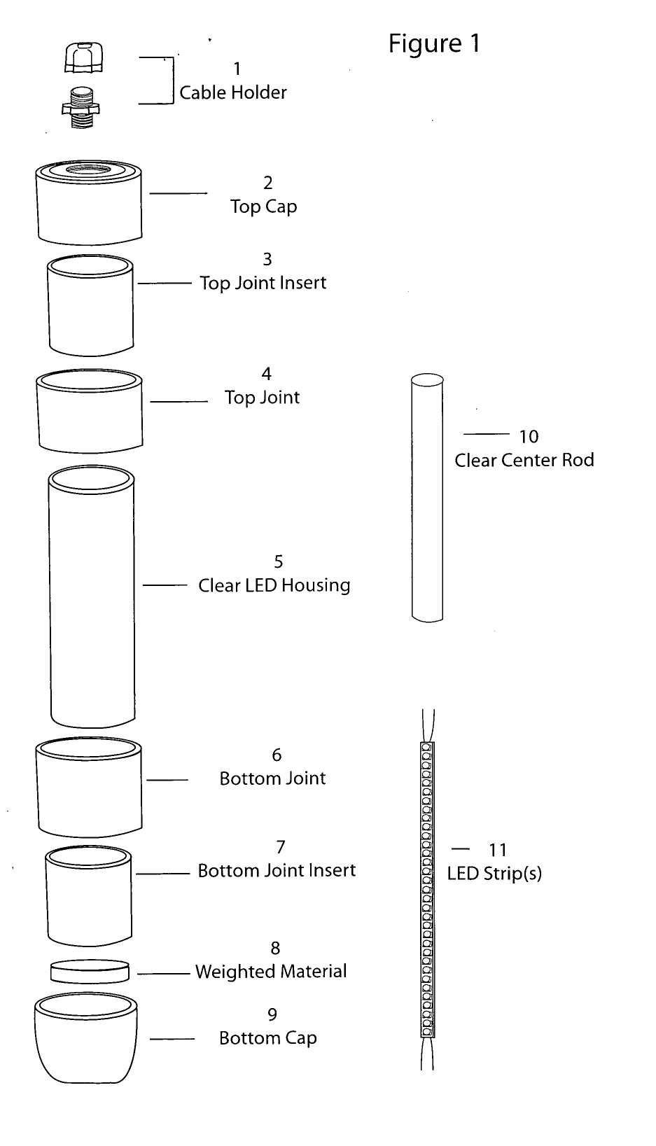

FIG. 1 shows a drawing of the parts needed to assemble the submersible and/or floating aquatic LED light. The parts needed are: an electrical cable holder (1), top cap (2) preferably a pvc reducer to npt for the cable holder, a top joint insert (3) preferably a 2″ long piece of pvc pipe, a top joint (4) preferably a pvc coupling, a clear LED housing (5) preferably a clear pvc or acrylic tube, a bottom joint (6) preferably a pvc coupling, a bottom joint insert (7) preferably a 2″ long piece of pvc pipe, weighted material (8) preferably lead weight, a bottom cap (9) preferably a pvc cap, a clear center rod (10) preferably a acrylic rod, and LED strip(s) (11) preferably one continuous strip.

Once all the parts are gathered we can begin to assemble the submersible and/or floating aquatic LED light. First we will need to glue the bottom joint insert (7) to the bottom cap (9). Then we will need to place the weighted material (8) inside the glued bottom joint insert (7) and the bottom cap (9). We will then need to glue the bottom joint (6) and the top joint (3) to the clear LED housing. We will then need to glue the bottom cap (9) with the weighted material (8) and the bottom joint insert (7) to the bottom joint (6). We will also need to glue the top joint insert (3) to the top joint (4). Now we must get the LED strip(s) (11) wrapped, preferably horizontally, around the clear center rod (10), in a spiral design so the LED lights in the strip(s) rotate in 360 degrees or more. Once the LED strip(s) (11) has been wrapped around the clear center rod (10), we place the clear center rod (10) inside the clear LED housing (5) and glue it to the weighted material (8) inside the bottom joint insert (7) and bottom cap (9). Once the center rod (10) is centered and glued we can pour in the clear electrical isolative material, preferably casting epoxy, inside the clear LED housing (5). Once the isolative material has cured we need to glue the top cap (2) to the top joint insert (3). Once the top cap (2) is glued we can to feed the electrical cable from the LED strip(s) through the cable holder (1) and screw the cable holder (1) into the npt opening on top cap (2).

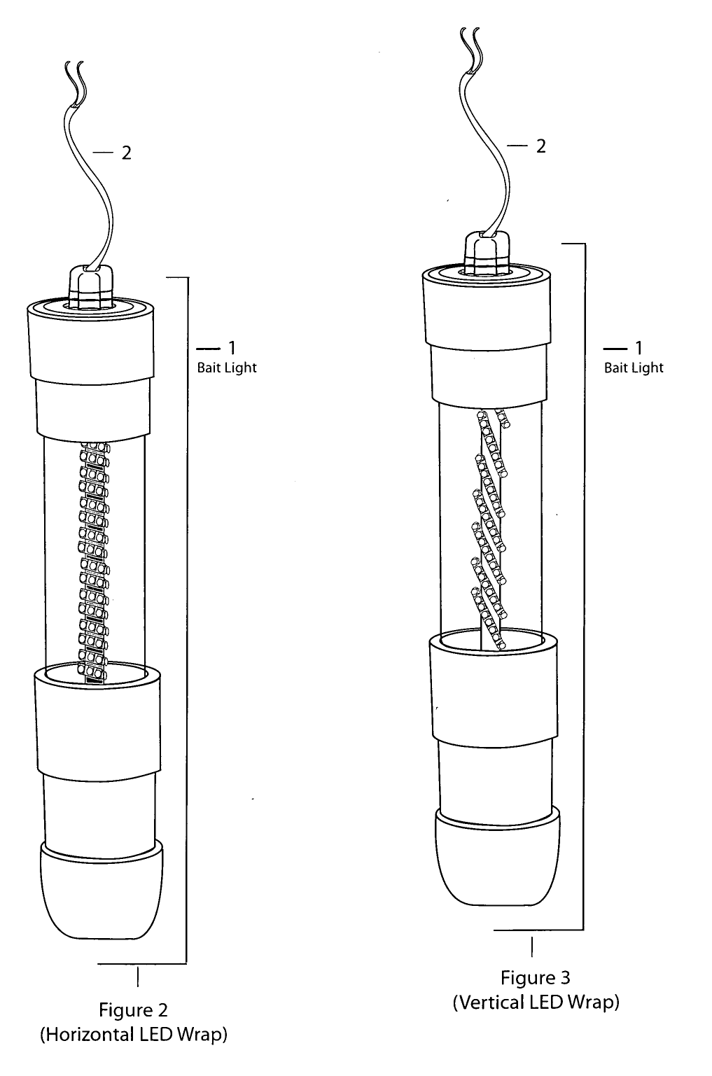

FIG. 2 shows an illustrative picture of the electrical cord (2) and the bait light (1) with the LED strip(s) horizontally wrapped around the center rod. By wrapping the LED strip(s) horizontally you can easily achieve a 360 degree and beyond rotation of he LEDs.

FIG. 3 shows an illustrative picture of the electrical cord (2) and the bait light with the LED strip(s) vertically wrapped around the center rod. By wrapping the LED strip(s) vertically you can control the degrees the LED will rotate better.

It will be understood that the aquatic of light FIGS. 1, 2, and 3 of the present invention described herein are merely exemplary and that a person skilled in the art may make many variations and modifications without departing from the spirit and scope of the invention. For example, the power maybe supplied by smaller more portable batteries to the under water light assembly FIG. 1, FIG. 2, and/or FIG. 3 associated with the above. Also, the optional electrical housing (FIGS. 1, 10) maybe removed to help rotate the LED strip 12. All such variations and modifications, including those discussed above, are intended to be within the scope of the invention as defined in the claims.

What is claimed is:

1. A submersible and/or floating aquatic LED light to attract fish, comprising: LED strip(s), a center rod, weighted material, clear protection tube, and the LED strip(s) are wrapped in a spiral design.

2. A submersible and/or floating aquatic LED light to attract fish were the LED housing is filled with an electrical isolative transparent material.

3. The submersible and/or floating aquatic LED light of claim 1, wherein said LED strip(s) color is green, blue, red, pink, orange, or any other color or color combination.

4. The submersible and/or floating aquatic LED light of claim 1, wherein said a spiral design the LED strip(s) are wrapped around the center rod from 90 degrees to beyond 720 degrees in a vertical or horizontal manner.

5. The submersible and/or floating aquatic LED light of claim 1, wherein said a center rod consists of a transparent rod, preferably acrylic, to wrap the LED Strip(s).

6. The submersible and/or floating aquatic LED light of claim 1, wherein said weighted material consisted of any heavy material, preferably lead.

7. The submersible and/or floating aquatic LED light of claim 1, wherein said clear protection tube consists of a transparent tube, preferably pvc tube, to protect the LED strip(s), and holds the electrical isolative transparent material of claim 2.

8. The submersible and/or floating aquatic LED light of claim 2, wherein said electrical isolative transparent materials consists of a transparent filler, preferably casting epoxy, to protect LED strip(s) from coming into contact with any water intrusion, and to protect from abuse.
